(19) United States
(12) Patent Application Publication
(10) Pub. No.: US 2014/0160124 A1
(43) Pub. Date: Jun. 12, 2014

(54) VISIBLE POLYGON DATA STRUCTURE AND METHOD OF USE THEREOF

(71) Applicant: NVIDIA CORPORATION, Santa Clara, CA (US)

(72) Inventors: Louis Bavoil, Courbevoie (FR); Miguel Sainz, Theale (GB)

(73) Assignee: NVIDIA CORPORATION, Santa Clara, CA (US)

(21) Appl. No.: 13/712,797

(22) Filed: Dec. 12, 2012

(51) Int. Cl. G06T 17/10

(52) U.S. Cl. CPC G06T 17/10
USPC 345/420

(57) ABSTRACT

A visible polygon data structure and method of use thereof. One embodiment of the visible polygon data structure includes: (1) a memory configured to store a data structure containing vertices of at least partially visible polygons of the scene but lacking vertices of at least some wholly invisible polygons of the scene, and (2) a graphics processing unit (GPU) configured to employ the vertices of the at least partially visible polygons to approximate an ambient occlusive effect on a point in the scene, the effect being independent of the wholly invisible polygons.

### TECHNICAL FIELD

This application is directed, in general, to computer graphics and, more specifically, to techniques for approximating ambient occlusion in graphics rendering.

### BACKGROUND

Many computer graphic images are created by mathematically modeling the interaction of light with a three dimensional scene from a given viewpoint. This process, called “rendering,” generates a two-dimensional image of the scene from the given viewpoint, and is analogous to taking a photograph of a real-world scene.

As the demand for computer graphics, and in particular for real-time computer graphics, has increased, computer systems with graphics processing subsystems adapted to accelerate the rendering process have become widespread. In these computer systems, the rendering process is divided between a computer's general purpose central processing unit (CPU) and the graphics processing subsystem, architecturally centered about a graphics processing unit (GPU). Typically, the CPU performs high-level operations, such as determining the position, motion, and collision of objects in a given scene. From these high level operations, the CPU generates a set of rendering commands and data defining the desired rendered image or images. For example, rendering commands and data can define scene geometry, lighting, shading, texturing, motion, and/or camera parameters for a scene. The graphics processing subsystem creates one or more rendered images from the set of rendering commands and data.

Scene geometry is typically represented by geometric primitives, such as points, lines, polygons (for example, triangles and quadrilaterals), and curved surfaces, defined by one or more two- or three-dimensional vertices. Each vertex may have additional scalar or vector attributes used to determine qualities such as the color, transparency, lighting, shading, and animation of the vertex and its associated geometric primitives.

Many graphics processing subsystems are highly programmable through an application programming interface (API), enabling complicated lighting and shading algorithms, among other things, to be implemented. To exploit this programmability, applications can include one or more graphics processing subsystem programs, which are executed by the graphics processing subsystem in parallel with a main program executed by the CPU. Although not confined merely to implementing shading and lighting algorithms, these graphics processing subsystem programs are often referred to as “shading programs,” “programmable shaders,” or simply “shaders.”

Ambient occlusion, or AO, is an example of a shading algorithm, commonly used to add a global illumination look to rendered images. AO is not a natural lighting or shading phenomenon. In an ideal system, each light source would be modeled to determine precisely the surfaces it illuminates and the intensity at which it illuminates them, taking into account reflections, refractions, scattering, dispersion and occlusions. In computer graphics, this analysis is accomplished by ray tracing or “ray casting.” The paths of individual rays of light are traced throughout the scene, colliding and reflecting off various surfaces.

In non-real-time applications, each surface in the scene can be tested for intersection with each ray of light, producing a high degree of visual realism. This presents a practical problem for real-time graphics processing: rendered scenes are often very complex, incorporating many light sources and many surfaces, such that modeling each light source becomes computationally overwhelming and introduces large amounts of latency into the rendering process. AO algorithms address the problem by modeling light sources with respect to an occluded surface in a scene: as white hemi-spherical lights of a specified radius, centered on the surface and oriented with a normal vector at the occluded surface. Surfaces inside the hemi-sphere cast shadows on other surfaces. AO algorithms approximate the degree of occlusion caused by the surfaces, resulting in concave areas such as creases or holes appearing darker than exposed areas. AO gives a sense of shape and depth in an otherwise “flat-looking” scene.

Several methods are available to compute AO, but its sheer computational intensity makes it an unjustifiable luxury for most real-time graphics processing systems. To appreciate the magnitude of the effort AO entails, consider a given point on a surface in the scene and a corresponding hemi-spherical normal-oriented light source surrounding it. The illumination of the point is approximated by integrating the light reaching the point over the hemi-spherical area. The fraction of light reaching the point is a function of the degree to which other surfaces obstruct each ray of light extending from the surface of the sphere to the point.

A popular alternative to AO in non-real-time applications is point-based global illumination (PBGI). In PBGI, directly illuminated geometry is represented as point clouds containing “surfels.” The surfels are organized in an octree, and the power from the surfels in each octree node is approximated either as a single large surfel or using spherical harmonics. Indirect illumination of a point is computed by rasterizing light from all surfels. PBGI algorithms can be as fast as ray-traced AO and can handle complex geometry and light sources with little incident noise, yielding visually acceptable, consistent results.

### SUMMARY

One aspect provides a graphics processing subsystem operable to render a scene. In one embodiment, the graphics processing subsystem includes: (1) a memory configured to store a data structure containing vertices of at least partially visible polygons of the scene but lacking vertices of at least some wholly invisible polygons of the scene, and (2) a graphics processing unit (GPU) configured to employ the vertices of the at least partially visible polygons to approximate an ambient occlusive effect on a point in the scene, the effect being independent of the wholly invisible polygons.

Another aspect provides a method of identifying a subset of surfaces in a scene formed by a plurality of pixels, the subset being a set of potentially occlusive surfaces. In one embodiment, the method includes: (1) rendering the surfaces in the scene as a collection of opaque polygons, and (2) forming the subset from the collection of opaque polygons such that each opaque polygon of the subset is visible in at least one of the plurality of pixels.

Yet another aspect provides a method of approximating ambient occlusion of a point in a scene containing a plurality of surfaces, the scene being formed by a plurality of pixels. In one embodiment, the method includes: (1) rendering the plurality of surfaces as a collection of opaque polygons having a plurality of vertices, (2) for each of the plurality of pixels, determining which of the collection of opaque polygons is visible and adding the determined opaque polygon to a list of potential occluding surfaces, and (3) rendering approximate AO based on the potential occluding surfaces in the list.

### BRIEF DESCRIPTION

Reference is now made to the following descriptions taken in conjunction with the accompanying drawings, in which:

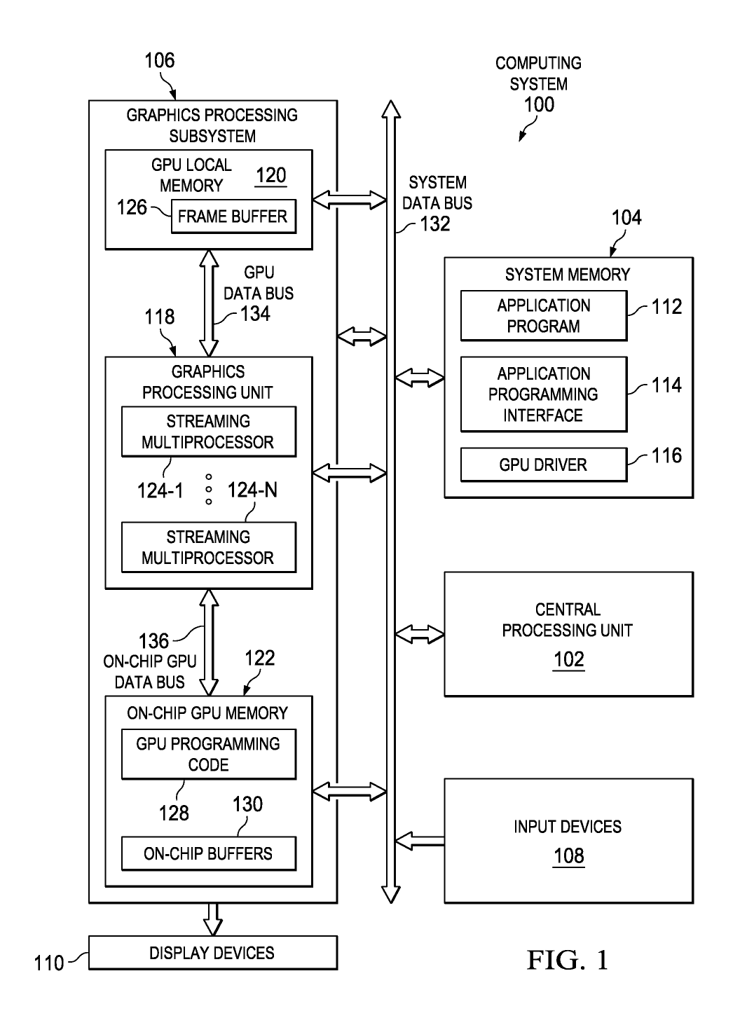

FIG. 1 is a block diagram of one embodiment of a computing system in which one or more aspects of the invention may be implemented;

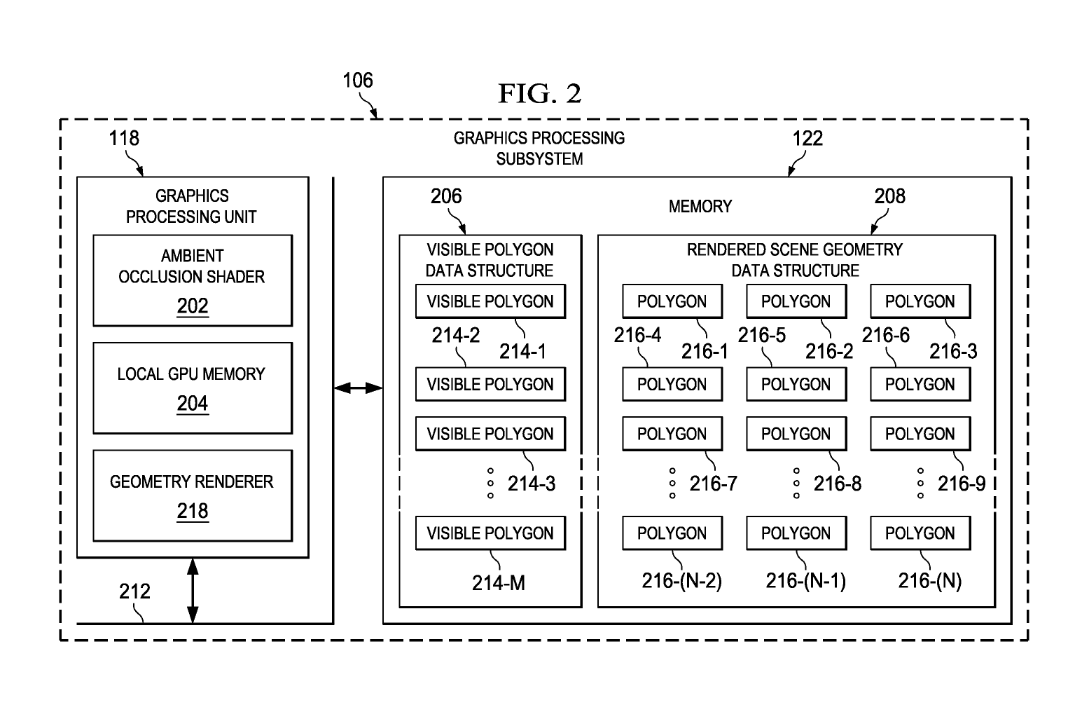

FIG. 2 is a block diagram of one embodiment of a graphics processing subsystem configured to render a scene having ambient occlusion;

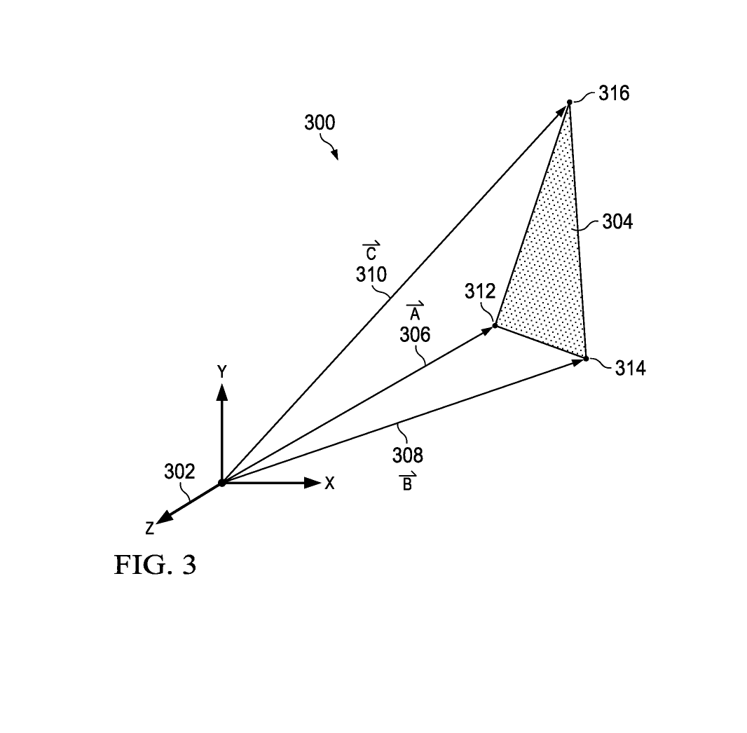

FIG. 3 is an illustration of one embodiment of a polygonal geometry in a scene;

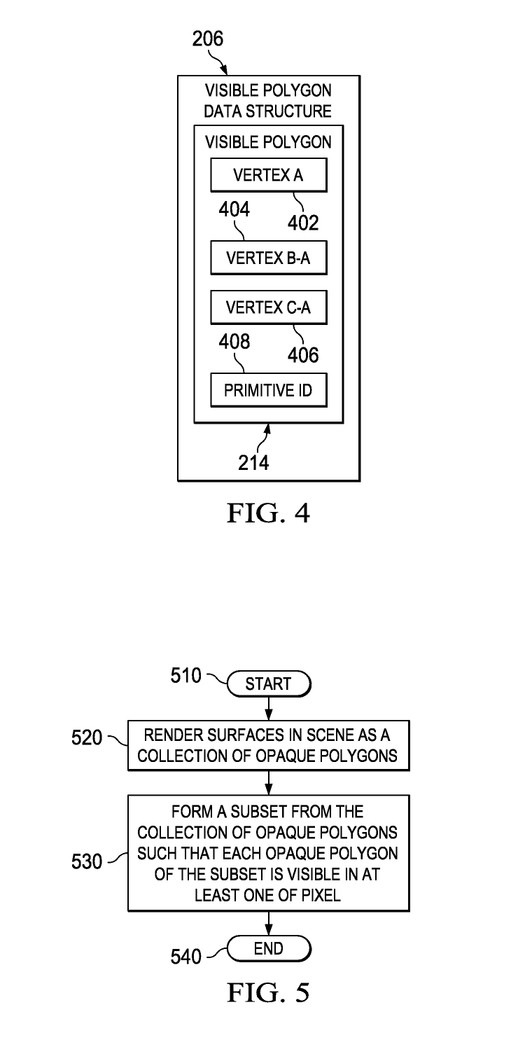

FIG. 4 is a block diagram of one embodiment of a visible polygon data structure; and

FIG. 5 is a flow diagram of one embodiment of a method of identifying a subset of surfaces in a scene.

### DETAILED DESCRIPTION

Before describing various embodiments of the visible polygon data structure or methods of use introduced herein, AO techniques will be generally described.

A well-known class of AO algorithms is screen-space AO, or SSAO. Screen-space is a reference to a late stage in the graphics pipeline, just before displaying a scene, where shading and texturing processes are carried out pixel-by-pixel. Surfaces in the scene are constructed in screen-space from a depth buffer. The depth buffer contains a per-pixel representation of a Z-axis depth of each pixel rendered, the Z-axis being normal to the display plane or image plane (also the XY-plane). The depth data forms a depth texture for the scene. SSA° algorithms operate on the depth texture and sometimes surface normal vectors to approximate AO.

A limitation of screen-space techniques is the lack of data available at that stage of the graphics pipeline. The depth buffer lacks data on surfaces outside the view frustrum. Consequently, conventional AO techniques only consider visible geometry. In other words, surfaces behind visible occluders are not considered occluders themselves. Ambient occlusion not considering these hidden occluders produces “halo” artifacts in the rendered scene, most noticeably near large depth discontinuities.

It is realized herein that common techniques for mitigating the lack of data in screen-space are unnecessarily slow, biased and require much more depth information than conventional SSA° algorithms. These common techniques include depth-peeling and multiple view-points, both of which involve redundant processing. It is further realized herein that an AO volumes technique suffers similar performance limitations due to high overdraw on large extruded volumes. Similarly, it is realized herein that PBGI is limited in the primitives it supports, requiring use of micro-polygons.

It is fundamentally realized herein that visible surfaces contribute the most AO effect, and that this contribution comes from the entire polygonal surface, and not just from wholly visible fragments. It is realized herein that all geometry in a scene is either wholly invisible or at least partially visible, or simply “visible.” It is further realized herein that excluding wholly invisible polygons from AO processing is faster than processing AO for all scene geometry, and has little detrimental effect on visual quality and plausibility.

It is fundamentally realized herein that the set of visible polygons in the scene may be made available in screen-space with basic additions to a geometry buffer, or G-buffer. It is realized herein that the visible polygons in the scene may be identified during rendering of each pixel and then stored in the G-buffer. It is further realized herein that the visible polygons may be represented in the G-buffer by their respective vertices. It is also realized herein that a primitive ID number associated with each polygon is also useful information further down the graphics pipeline for processes aimed at reducing redundancy in the set of visible polygons.

It is realized herein that that in screen-space, when sampling visible geometry for potential occluding surfaces, a sample should include the complete polygon of the visible geometry that is now available in the G-buffer. It is further realized herein that the complete polygon may be reconstructed in screen-space and evaluated for ambient occlusion. It is further realized herein that the evaluation for ambient occlusion may be by a variety of techniques including ray-tracing and ray-marching, where the reconstructed polygon is tested for intersection with individual light rays.

Before describing various embodiments of the visible polygon data structure or methods of use introduced herein, a computing system within which the visible polygon data structure and methods may be embodied or carried out will be described.

FIG. 1 is a block diagram of one embodiment of a computing system 100 in which one or more aspects of the invention may be implemented. The computing system 100 includes a system data bus 132, a central processing unit (CPU) 102, input devices 108, a system memory 104, a graphics processing subsystem 106, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, and configures the graphics processing subsystem 106 to perform specific tasks in the graphics pipeline. The system memory 104 typically includes dynamic random access memory (DRAM) employed to store programming instructions and data for processing by the CPU 102 and the graphics processing subsystem 106. The graphics processing subsystem 106 receives instructions transmitted by the CPU 102 and processes the instructions in order to render and display graphics images on the display devices 110.

As also shown, the system memory 104 includes an application program 112, one or more application programming interfaces (APIs) 114, and a graphics processing unit (GPU) driver 116. The application program 112 generates calls to the API 114 in order to produce a desired set of results, typically in the form of a sequence of graphics images. The application program 112 also transmits zero or more high-level shading programs to the API 114 for processing within the GPU driver 116. The high-level shading programs are typically source code text of high-level programming instructions that are designed to operate on one or more shading engines within the graphics processing subsystem 106. The API 114 functionality is typically implemented within the GPU driver 116. The GPU driver 116 is configured to translate the high-level shading programs into machine code shading programs that are typically optimized for a specific type of shading engine (e.g., vertex, geometry, or fragment).

The graphics processing subsystem 106 includes a graphics processing unit (GPU) 118, an on-chip GPU memory 122, an on-chip GPU data bus 136, a GPU local memory 120, and a GPU data bus 134. The GPU 118 is configured to communicate with the on-chip GPU memory 122 via the on-chip GPU data bus 136 and with the GPU local memory 120 via the GPU data bus 134. The GPU 118 may receive instructions transmitted by the CPU 102, process the instructions in order to render graphics data and images, and store these images in the GPU local memory 120. Subsequently, the GPU 118 may display certain graphics images stored in the GPU local memory 120 on the display devices 110.

The GPU 118 includes one or more streaming multiprocessors 124. Each of the streaming multiprocessors 124 is capable of executing a relatively large number of threads concurrently. Advantageously, each of the streaming multiprocessors 124 can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on. Furthermore, each of the streaming multiprocessors 124 may be configured as a shading engine that includes one or more programmable shaders, each executing a machine code shading program (i.e., a thread) to perform image rendering operations. The GPU 118 may be provided with any amount of on-chip GPU memory 122 and GPU local memory 120, including none, and may employ on-chip GPU memory 122, GPU local memory 120, and system memory 104 in any combination for memory operations.

The on-chip GPU memory 122 is configured to include GPU programming code 128 and on-chip buffers 130. The GPU programming 128 may be transmitted from the GPU driver 116 to the on-chip GPU memory 122 via the system data bus 132. The GPU programming 128 may include a machine code vertex shading program, a machine code geometry shading program, a machine code fragment shading program, or any number of variations of each. The on-chip buffers 130 are typically employed to store shading data that requires fast access in order to reduce the latency of the shading engines in the graphics pipeline. Since the on-chip GPU memory 122 takes up valuable die area, it is relatively expensive.

The GPU local memory 120 typically includes less expensive off-chip dynamic random access memory (DRAM) and is also employed to store data and programming employed by the GPU 118. As shown, the GPU local memory 120 includes a frame buffer 126. The frame buffer 126 stores data for at least one two-dimensional surface that may be employed to drive the display devices 110. Furthermore, the frame buffer 126 may include more than one two-dimensional surface so that the GPU 118 can render to one two-dimensional surface while a second two-dimensional surface is employed to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which the visible polygon data structure or methods of use may be embodied or carried out, various embodiments of the visible polygon data structure and methods of use will be described.

FIG. 2 is a block diagram of one embodiment of the graphics processing subsystem 106 of FIG. 1. In the embodiment of FIG. 2 graphics processing subsystem 106 includes a graphics processing unit (GPU) 118 and memory 122, both of FIG. 1. GPU 118 and memory 122 communicate over a data bus 212. In certain embodiments a data bus between memory 122 and GPU 118 may be isolated from a data bus between graphics processing subsystem and an external system. In other embodiments, the data bus is shared. In the embodiment of FIG. 2, GPU 118 contains a geometry renderer 218, an ambient occlusion shader 202 and a local GPU memory 204. Certain embodiments of GPU 118 may lack local GPU memory 204 entirely.

Memory 122 of FIG. 2 includes a visible polygon data structure 206 and a rendered scene geometry data structure 208. Rendered scene geometry data structure 208 contains data for N polygons, polygon 216-1 through polygon 216-N. The value of N depends entirely on the complexity of the scene rendered. Visible polygon data structure 206 is configured to store M at least partially visible polygons rendered in the scene, visible polygon 214-1 through visible polygon 214-M. The value of M also depends on the screen resolution, but always a subset of the polygons 216-1 through 216-N stored in rendered scene geometry data structure 208.

When a complete scene is rendered by geometry renderer 218, the primitive polygons in the scene are stored in rendered scene geometry data structure 208. During rendering, a pixel-by-pixel determination is made as to which polygon is visible. For each pixel, a visible polygon 214 is identified or “hooked,” and each of visible polygons 214-1 through 214-M is stored in visible polygon data structure 206. Those skilled in the pertinent art are familiar with this conventional process, in which a G-buffer is filled with reference to Z-axis depth. Certain embodiments may not store visible polygon data structure 206, but rely on a primitive ID of visible polygons 214-1 through 214-M to reconstruct the polygons from a scene database. This is particularly useful for fully static scenes. Continuing with the embodiment of FIG. 2, once the scene is rendered and the graphics pipeline moves into screen-space, ambient occlusion shader 202 retrieves data from visible polygon data structure and carries out AO shading. The AO shading considers the complete surfaces of visible polygons 214-1 through 214-M as opposed to only the visible fragments.

FIG. 3 is an illustration of an opaque polygon 304 in a scene 300. Opaque polygon 304 is an opaque triangle, but in alternative embodiments may also be a quadrilateral, micro-polygon or other n-sided polygon. Opaque polygon 304 of FIG. 3 is drawn with respect to a world reference frame 302 shared by all other geometries in scene 300. Vertex A 312, vertex B 314 and vertex C 316 are absolute positions with respect to world reference frame 302. The positions are respectively represented by vectors \vec{A} 306, \vec{B} 308 and \vec{C} 310, also with respect to world reference frame 302.

FIG. 4 is a block diagram of one embodiment of visible polygon data structure 206 of FIG. 2, configured to store visible polygon data 214, also of FIG. 2. In the embodiment of FIG. 4, visible polygon 214 contains three vertices of opaque polygon 304 of FIG. 3: vertex A 402, vertex B-A 404 and vertex C-A 406. Visible polygon 214 also contains a primitive ID 408.

Vertex B-A 404 is a compressed representation of vertex B 314 of FIG. 3. While vertex A 402 is an absolute representation of vertex A 312 with respect to world reference frame 302, vertex B-A 404 is a vector subtraction of vectors \vec{B} 308 and \vec{A} 306, generally yielding a vector having less magnitude than vector \vec{B} 308 alone. Similarly, vertex C-A 406 is a compressed representation of vertex C 316 also of FIG. 3. Alternate embodiments may configure visible polygon data structure 206 to store more absolute vertex positions and fewer relative vertex positions. Other embodiments will store more than three vertices per visible polygon 214, according to the primitive shape on which screen-space algorithms will operate. For instance, certain embodiments of visible polygon 214 may store four vertices to represent quadrilateral geometry properly.

FIG. 5 is a flow diagram of an embodiment of a method of identifying visible polygons in a scene. The scene contains multiple geometries or surfaces to be rendered and rasterized onto pixels. The method begins at a start step 510. The surfaces are rendered in step 520 as a collection of opaque polygons. In a step 530, a pixel-by-pixel analysis is carried out to determine which opaque polygon in the collection is visible in each pixel (using Z-axis depth). Once that determination is made, the entire surface, not just the visible fragment, can be used further down the graphics pipeline. The method ends at an end step 540.

In certain embodiments the method includes an SSAO step where pixel shading is carried out using an AO technique employing the subset containing visible opaque polygons. Certain embodiments may employ a ray-tracing AO technique, while other embodiments may employ a ray-marching or other SSAO technique.

Those skilled in the art to which this application relates will appreciate that other and further additions, deletions, substitutions and modifications may be made to the described embodiments.

What is claimed is:

1. A graphics processing subsystem operable to render a scene, comprising:
a memory configured to store a data structure containing vertices of at least partially visible polygons of said scene but lacking vertices of at least some wholly invisible polygons of said scene; and
a graphics processing unit (GPU) configured to employ said vertices of said at least partially visible polygons to approximate an ambient occlusive effect on a point in said scene, said effect being independent of said wholly invisible polygons.

2. The graphics processing subsystem recited in claim 1 wherein said data structure lacks all wholly invisible polygons.

3. The graphics processing subsystem recited in claim 1 wherein said at least partially visible polygons is a plurality of visible opaque triangles.

4. The graphics processing subsystem recited in claim 1 wherein said ambient occlusive effect is approximated by a ray tracing technique.

5. The graphics processing subsystem recited in claim 1 wherein said ambient occlusive effect is approximated by a ray marching technique.

6. The graphics processing subsystem recited in claim 1 wherein at least one of said vertices contained in said data structure is an offset from an absolute position in said scene.

7. The graphics processing subsystem recited in claim 1 wherein said data structure further contains a primitive identifier associated with each of said at least partially visible polygons.

8. A method of identifying a subset of surfaces in a scene formed by a plurality of pixels, said subset being a set of potentially occlusive surfaces, comprising:
rendering said surfaces in said scene as a collection of opaque polygons; and
forming said subset from said collection of opaque polygons such that each opaque polygon of said subset is visible in at least one of said plurality of pixels.

9. The method recited in claim 8 wherein said collection of opaque polygons is a collection of opaque triangles.

10. The method recited in claim 8 wherein each of said collection of opaque polygons is defined by a plurality of vertices.

11. The method recited in claim 10 wherein said plurality of vertices comprises an absolute position of a vertex and a plurality of position offsets from said absolute position.

12. The method recited in claim 8 wherein said collection of opaque polygons is stored in a memory.

13. The method recited in claim 8 further comprising approximating screen space ambient occlusion (SSAO) independent of opaque polygons excluded from said subset containing said potentially occlusive surfaces.

14. The method recited in claim 13 wherein said approximating comprises a ray tracing ambient occlusion evaluation.

15. A method of approximating ambient occlusion of a point in a scene containing a plurality of surfaces, said scene being formed by a plurality of pixels, comprising:
rendering said plurality of surfaces as a collection of opaque polygons having a plurality of vertices;
for each of said plurality of pixels, determining which of said collection of opaque polygons is visible and adding the determined opaque polygon to a list of potential occluding surfaces; and
rendering approximate AO based on the potential occluding surfaces in the list.

16. The method recited in claim 15 wherein said collection of opaque polygons is a collection of opaque triangles.

17. The method recited in claim 15 further comprising removing duplicative opaque polygons from said list of potential occluding surfaces.

18. The method recited in claim 15 wherein said plurality of vertices comprises an absolute position and a plurality of offset positions from said absolute position.

19. The method recited in claim 15 wherein said rendering is carried out by a ray tracing technique.

20. The method recited in claim 15 wherein said rendering is carried out by a ray marching technique.
